(19) United States
(12) Patent Application Publication
(10) Pub. No.: US 2023/0118371 A1
(43) Pub. Date: Apr. 20, 2023

(54) MOTOR DRIVEN ADJUSTABLE ANTI-JAM DEVICE FOR EXPANDING SLIT CUSHIONING MATERIAL

(71) Applicant: Intertape Polymer Group Inc., Sarasota, FL (US)

(72) Inventor: Raimond Demers, Sarasota, FL (US)

(21) Appl. No.: 17/952,655

(22) Filed: Sep. 26, 2022

Related U.S. Application Data
(60) Provisional application No. 63/248,873, filed on Sep. 27, 2021.

(51) Int. Cl. B65H 23/26; B65H 20/02; B65H 26/02

(52) U.S. Cl. CPC B65H 23/26; B65H 20/02; B65H 26/02; B65H 2404/153; B65H 2404/632; B65H 2515/30

(57) ABSTRACT

A device for dispensing a roll of sheet stock material includes a first pair of rollers. The first pair of rollers is driven by an electric motor. The first pair of rollers is configured to receive expandable slit paper between the first pair of rollers. The first pair of rollers is configured to modify a force of friction applied to an outer surface of the expandable slit paper.

### PRIORITY CLAIM AND CROSS-REFERENCE TO RELATED APPLICATIONS

This application claims priority to U.S. Provisional Pat. App. No. 63/248,873, filed on Sep. 27, 2021, titled MOTOR DRIVEN DEVICE FOR CONSTANT FRICTION ROLLER, the entire contents of which are incorporated by reference herein in their entirety and relied upon.

### FIELD

The present disclosure relates generally to motor driven devices for packaging machines. More specifically, this disclosure relates to small footprint motor driven devices with an adjustable anti-jam device that can be attached to, and detached from, a manual device for expanding a roll of slit material into expanded slit cushioning material.

### BACKGROUND

Slit sheet paper packing material increases in thickness when stretched. This stretching and increase in thickness of the slit sheet paper packing material is referred to as expansion. Slit sheet paper packing material typically includes a paper with rows of die cut slit into the paper. The thickness of the slit sheet paper packing material increases relative to its original thickness, when stretched. This increased thickness allows the expanded material to serve as a protective cushioning wrap material. Slit sheet paper packing material is generally described in U.S. Pat. No. 5,667,871 and No. 5,688,578.

There are two common types of dispenser devices available in the market today for dispensing slit sheet paper packing material. The first type of dispenser device is a manual dispensing device whereby the sheet stock material needs to be pulled manually to dispense cushioning material. Manual devices are typically implemented in packaging environments where the amount of packaging material needed is on the lower end (e.g., low to mid volume end-users). Because the sheet stock material needs to be pulled by a manual action, the user may experience ergonomic discomfort over time, particularly as volume increases.

The second type of dispenser device is a motor driven machine, which is typically implemented in packaging environments where the amount of packaging material needed is on the higher end (e.g., mid to high volume end-users). A motor driven machine may include a feeding system, whereby the packaging material is dispensed by activating a foot pedal; material dispensation is stopped by releasing the foot pedal. Motor driven machines may reduce ergonomic discomfort as there is no need for the user to manually pull the sheet stock material into a cushioning material.

That said, motor-driven machines can lead to jamming: if paper gets clogged in a roller, motor-driven aspects can exacerbate the jam. Furthermore, dispenser devices, whether manual or motor driven, may encounter sub-optimal expansion of the slit paper when the slit paper varies in thickness (e.g., due to pre-set roller spacing). This can, likewise, cause jamming. Both jams and sub-optimal expansion introduce undesirable inefficiencies into the overall process for expanding slit paper into expanded slit cushioning material.

Lastly, with both types of dispenser devices, manual or motor driven, the devices are most often placed on a tabletop of a packing station, such that sheet stock material may be readily expanded and subsequently used to wrap and protect products as the products are packed into cardboard boxes. Packing stations are usually rather crowded, including other devices such as barcode scanners, printing devices, label dispensers, and the like. Specifically, for example, a common tabletop may be between 60 and 80 cm deep, whereas a manual dispenser is between the 30 and 48 cm deep and a motor driven dispenser is between 37 and 51 cm deep. Because the packaging material needs to be “pulled” towards the user in order to wrap a product, the available space remaining is all the more limited.

Improved devices, systems, and methods for expanding a roll of slit paper into an expanded slit cushioning material, that have anti-jam features while simultaneously reducing the overall footprint of the systems, are therefore needed.

### SUMMARY

The motor driven devices disclosed herein improve on current packaging technology, by providing for improved expansion of expandable slit cushioning material that reduces jams and optimizes expansion. Moreover, these devices are configured for integration into existing systems that utilize manual constant friction, allowing for re-configuration of existing systems and/or reducing overall footprint of the systems themselves.

In light of the disclosure herein, and without limiting the scope of the invention in any way, in a first aspect of the present disclosure, which may be combined with any other aspect listed herein unless specified otherwise, a device for dispensing a roll of sheet stock material includes a first pair of rollers. The first pair of rollers is driven by an electric motor. The first pair of rollers is configured to receive expandable slit paper between the first pair of rollers. The first pair of rollers is configured to modify a force of friction applied to an outer surface of the expandable slit paper.

In a second aspect of the present disclosure, which may be combined with any other aspect listed herein unless specified otherwise, the first pair of rollers extend across an entire width of the expandable slit paper.

In a third aspect of the present disclosure, which may be combined with any other aspect listed herein unless specified otherwise, the device includes a second pair of rollers The first pair of rollers extend across a left edge of the expandable slit paper. The second pair of rollers extend across a right edge of the expandable slit paper. Neither the first pair of rollers nor the second pair of rollers extend across a middle of the expandable slit paper.

In a fourth aspect of the present disclosure, which may be combined with any other aspect listed herein unless specified otherwise, the device includes a first bracket on a left side of the device and includes a right bracket on the right side of the device, such that the device is configured to be coupled to the roll of sheet stock material via the first bracket and the second bracket.

In a fifth aspect of the present disclosure, which may be combined with any other aspect listed herein unless specified otherwise, when the device is coupled to the roll of sheet stock material, the roll of sheet stock material is disposed vertically above the device.

In a sixth aspect of the present disclosure, which may be combined with any other aspect listed herein unless specified otherwise, when the device is coupled to the roll of sheet stock material, the roll of sheet stock material is disposed vertically below the device.

In a seventh aspect of the present disclosure, which may be combined with any other aspect listed herein unless specified otherwise, the first pair of rollers includes a first roller and a second roller, the first roller includes a first anti-jam device, and the second roller includes a second anti-jam device.

In an eighth aspect of the present disclosure, which may be combined with any other aspect listed herein unless specified otherwise, the first anti-jam device is a gravity-biased hinge.

In a ninth aspect of the present disclosure, which may be combined with any other aspect listed herein unless specified otherwise, the second anti-jam device is a spring-biased hinge.

In a tenth aspect of the present disclosure, which may be combined with any other aspect listed herein unless specified otherwise, responsive to a jam, the second anti-jam device pivots away from the second roller.

In an eleventh aspect of the present disclosure, which may be combined with any other aspect listed herein unless specified otherwise, the second anti-jam device includes a spring, and the spring is adjustable via a set screw.

In a twelfth aspect of the present disclosure, which may be combined with any other aspect listed herein unless specified otherwise, the first pair of rollers includes a plurality of notches, the first anti-jam device includes a plurality of fingers, and each of the plurality of fingers extends into one of the plurality of notches.

In a thirteenth aspect of the present disclosure, which may be combined with any other aspect listed herein unless specified otherwise, a device for dispensing a roll of sheet stock material includes a first roller and a second roller. The first roller and the second roller are driven by an electric motor. The first roller and the second roller are configured to receive expandable slit paper between the first roller and the second roller. The first roller includes a first anti-jam device, the second roller includes a second anti-jam device, and the second anti-jam device is different from the first anti-jam device.

In a fourteenth aspect of the present disclosure, which may be combined with any other aspect listed herein unless specified otherwise, the device includes a first bracket on a left side of the device and includes a right bracket on the right side of the device, such that the device is configured to be coupled to the roll of sheet stock material via the first bracket and the second bracket.

In a fifteenth aspect of the present disclosure, which may be combined with any other aspect listed herein unless specified otherwise, when the device is coupled to the roll of sheet stock material, the roll of sheet stock material is disposed in a different vertical plane than a vertical plane of the device.

In a sixteenth aspect of the present disclosure, which may be combined with any other aspect listed herein unless specified otherwise, the first anti-jam device is a gravity-biased hinge.

In a seventeenth aspect of the present disclosure, which may be combined with any other aspect listed herein unless specified otherwise, the second anti-jam device is a spring-biased hinge.

In an eighteenth aspect of the present disclosure, which may be combined with any other aspect listed herein unless specified otherwise, responsive to a jam, the second anti-jam device pivots away from the second roller.

In a nineteenth aspect of the present disclosure, which may be combined with any other aspect listed herein unless specified otherwise, the second anti-jam device includes a spring, and the spring is adjustable via a set screw.

In a twentieth aspect of the present disclosure, which may be combined with any other aspect listed herein unless specified otherwise, the first roller includes a plurality of notches, the first anti-jam device includes a plurality of fingers, and each of the plurality of fingers extends into one of the plurality of notches.

Additional features and advantages of the disclosed devices, systems, and methods are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein. Moreover, it should be noted that the language used in the specification has been selected for readability and instructional purposes, and not to limit the scope of the inventive subject matter.

### BRIEF DESCRIPTION OF THE FIGURES

Understanding that figures depict only typical embodiments of the invention and are not to be considered to be limiting the scope of the present disclosure, the present disclosure is described and explained with additional specificity and detail through the use of the accompanying figures. The figures are listed below.

FIG. 1 illustrates a perspective view of a motor driven unit, according to an example embodiment of the present disclosure.

FIG. 2 illustrates a perspective view of a motor driven unit coupled with a supply roll, according to an example embodiment of the present disclosure.

FIG. 3 illustrates a perspective view of a motor driven unit coupled with a supply roll and disposed below the supply roll, according to an example embodiment of the present disclosure.

FIG. 4 illustrates a perspective view of a motor driven unit coupled with a supply roll and disposed above the supply roll, according to an example embodiment of the present disclosure.

FIG. 5 illustrates a perspective view of a motor driven unit integrally formed with a supply roll, according to an example embodiment of the present disclosure.

FIG. 6 illustrates a perspective cutaway view of a motor driven unit with anti-jam features, according to an example embodiment of the present disclosure.

FIG. 7 illustrates a perspective view of a spring-biased anti-jam feature, according to an example embodiment of the present disclosure.

FIG. 8 illustrates a perspective view of a motor driven unit gear system, according to an example embodiment of the present disclosure.

FIGS. 9A to 9B illustrate side views of a spring-biased anti-jam feature during a jam, according to an example embodiment of the present disclosure.

FIG. 10 illustrates a perspective view of an alternative roller embodiment, according to an example embodiment of the present disclosure.

FIG. 11 illustrates a side view of the alternative roller embodiment depicted in FIG. 10, according to an example embodiment of the present disclosure.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specific the presence of stated features, integers, steps, operations, elements, and/or components, but do not preclude the presence or additional of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent”). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

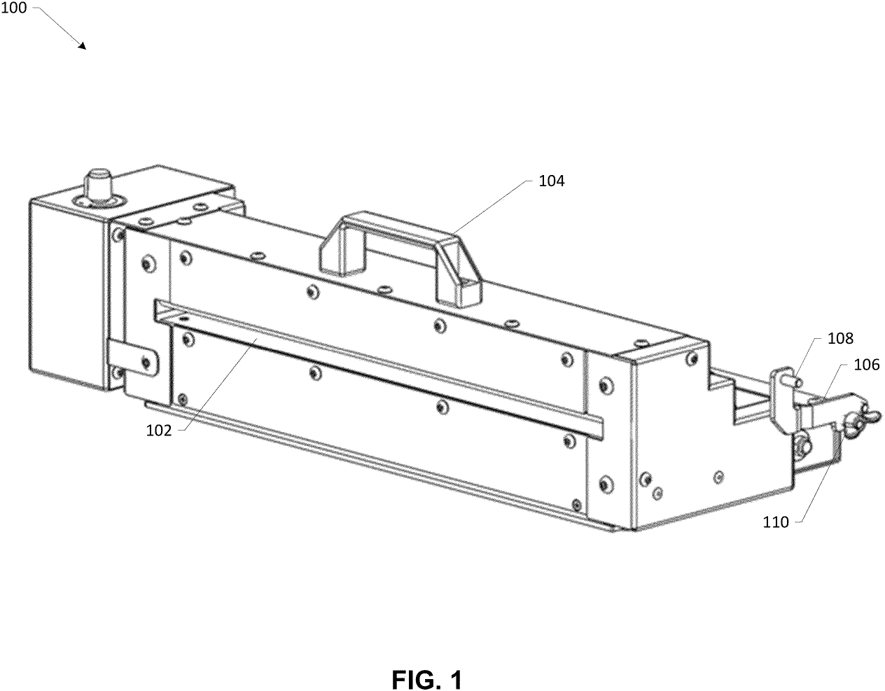

With reference to the Figures, FIG. 1 depicts a device 100, which can be used as a supplement or add-on to typical manual constant friction devices for expanding a roll of slit paper into an expanded slit cushioning material. Namely, manual constant friction devices require a user to “pull” a roll of slit paper between one or more rollers, such that it expands into the expanded slit cushioning material. By comparison, the device 100 depicted by FIG. 1 and disclosed herein assists the user with expanding the slit cushioning material and reducing jams via motor-driven rollers. And device 100 can be removably coupled to a manual constant friction device.

Generally, as illustrated in greater detail herein, device 100 includes a first pair of rollers. In an embodiment, the first pair of rollers is driven by an electric motor. The first pair of rollers is generally configured to receive expandable slit paper between the first pair of rollers. The first pair of rollers is configured to modify a force of friction applied to an outer surface of the expandable slit paper. Once expanded, the expandable slit paper is ejected from aperture 102, such that a user may receive the expandable slit paper and use it for packaging purposes.

Device 100 includes a handle 104 along its top side. Via handle 104, a user may manually carry device 100 (e.g., carry device 100 to a packaging table) and subsequently orient device 100 adjacent to a supply roll. Once the supply roll is fed into device 100, device 100 may operate as disclosed herein.

Device 100 may additionally include one or more adjustable mounts 106 with related protrusions 108. Mounts 106 may be slidably and/or pivotably adjustable with respect to device 100, such as via a wing-nut 110 or other related mechanical means. Mounts 106 can thus be used to mechanically engage device 100 with a supply roll.

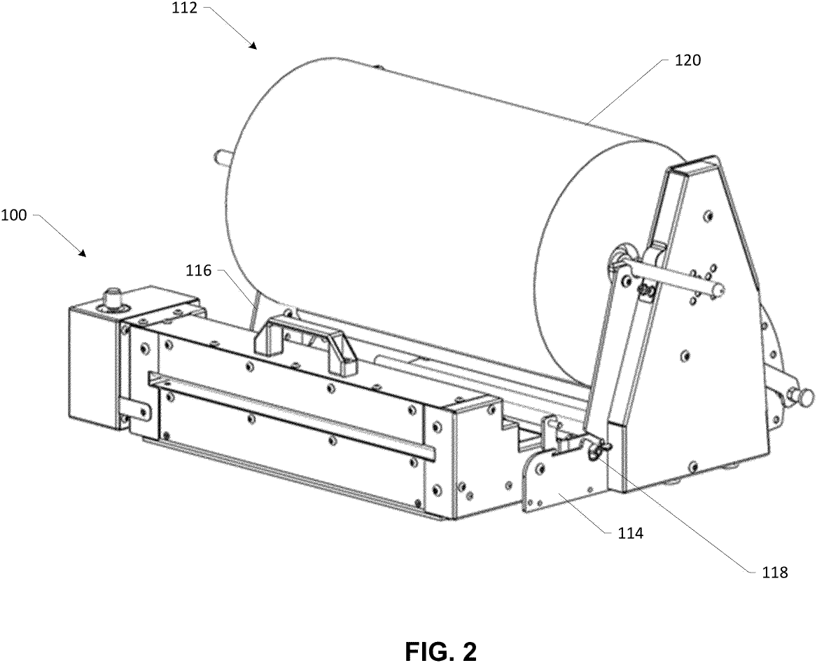

FIG. 2 illustrates a perspective view of device 100 mechanically coupled to a supply roll module 112. For example, supply roll module 112 includes side brackets 114, 116. Each of side brackets 114, 116 is configured to be disposed adjacent to one of mounts 106 on device 100. Specifically, each side bracket, such as side bracket 114, includes an aperture 118 (e.g., for receiving one or more of protrusions 108 and/or wing-nuts 110). In this way, mount 106 is removably coupleable with side bracket 114; it should be appreciated that similar mechanical engagement is contemplated with respect to side bracket 116 and an additional mount (not illustrated).

Supply roll module 112 further includes a supply roll 120 (e.g., a roll of slit cushioning material in an unexpanded state). Supply roll 120 is fed into device 100, such that device 100 may assist the user by expanding the supply material and ejecting the expanded material at aperture 102.

By being removably coupleable, device 100 can be transported by a user (e.g., via handle 104) to different packing stations to be used with different types of supply rolls 120. Furthermore, in example embodiments, device 100 is coupled with supply roll 120 so as to reduce the overall footprint of the packing system.

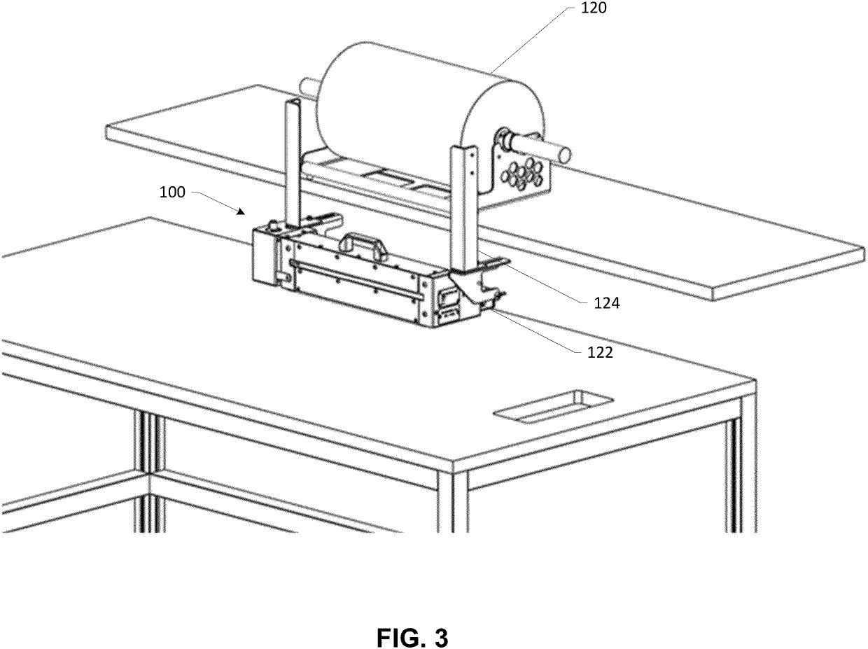

For example, FIG. 3 illustrates a perspective view of device 100 coupled with supply roll 120. In this example embodiment, device 100 includes a plurality of vertical support brackets 122 (e.g., individually coupled with mounts 106), where each of the vertical support brackets 122 receives a column 124. Via columns 124, device 100 is configured to be disposed vertically below supply roll 120, so as to reduce the overall footprint of device 100 and supply roll 120 on a packing table.

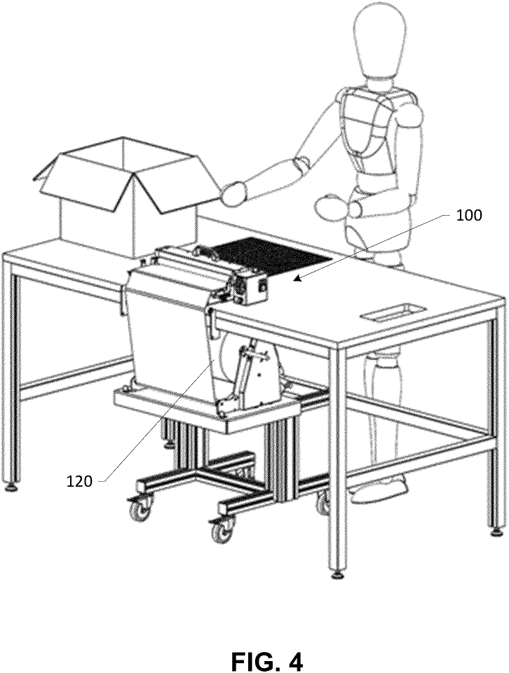

Similarly, for example, FIG. 4 illustrates a perspective view of device 100 coupled with supply roll 120. In this example embodiment, device 100 is configured to be disposed vertically above supply roll 120, so as to reduce the overall footprint of device 100 and supply roll 120 on a packing table.

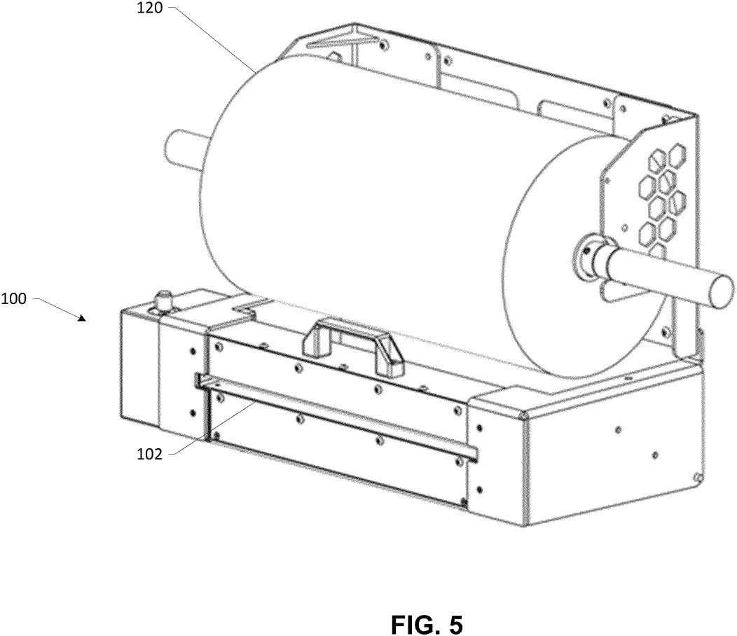

In yet another example, FIG. 5 illustrates a perspective view of device 100 formed integrally with supply roll 120. Integral formation reduces the need for mounting components (e.g., mounts 106, wing-nut 110, etc.); that said, integral formation means that device 100 cannot be readily removed from supply roll 120 and readily transported (e.g., to be used with a different supply roll or in a different location).

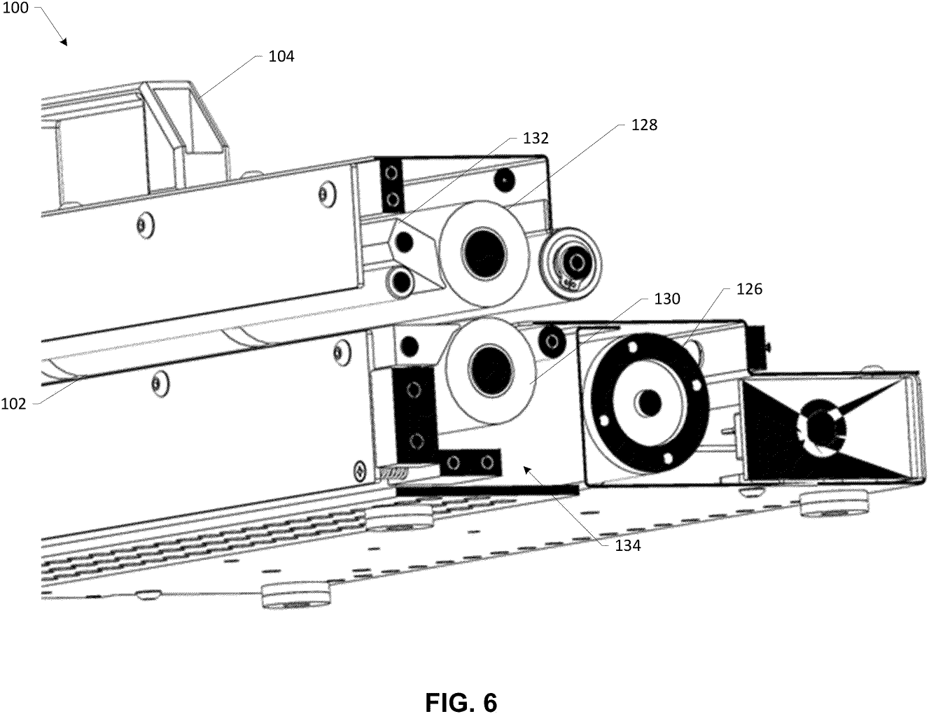

Turning back to the specific functionality of device 100, FIG. 6 illustrates a perspective cutaway view of device 100 with anti-jam features. Device 100 generally includes a housing. As illustrated, certain portions (e.g., the right side) of the housing for device 100 are removed to improve visibility.

Device 100 includes a drive roller 126. In an embodiment, drive roller 126 is powered by an electric motor disposed within device 100.

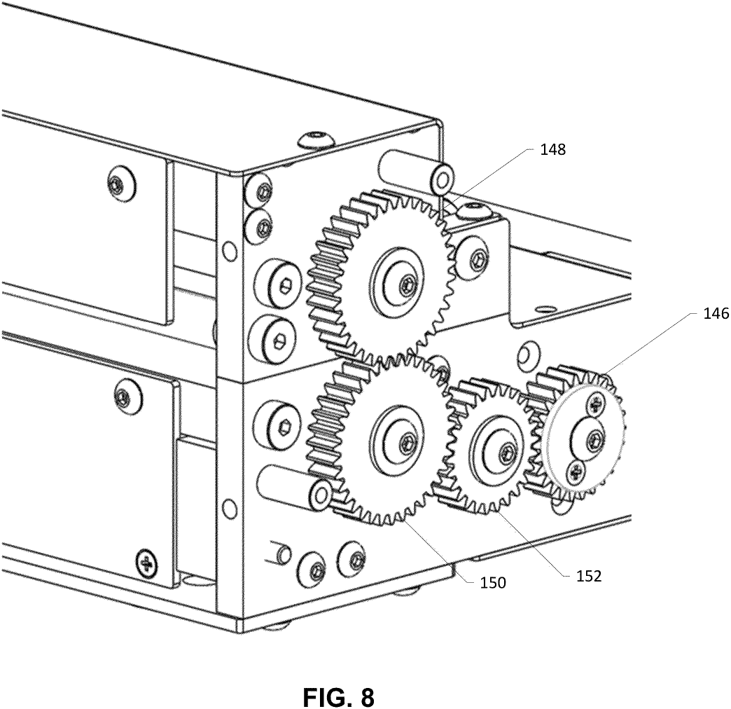

Device additionally includes a pair of rollers including first roller 128 and second roller 130. Drive roller 126 powers each of first roller 128 and second roller 130 (as illustrated in greater detail herein with respect to FIG. 8). First roller 128 and second roller 130 are generally configured to “expand” the expandable slit paper as it passes between the rollers 128, 130.

In an embodiment, the pair of rollers 128, 130 is adjustable, such that the spacing between first roller 128 and second roller 130 can be modified to accommodate different thicknesses of slit paper (e.g., single ply, multi-ply, common flat sheet stock, and the like) and/or different particular slit patterns (e.g., parallel spaced slits extending transversely). By being adjustable, the pair of rollers 128, 130 provides for the slit cushioning material to optimally expand, while avoiding undesirable flattening or undesirable deformation. Adjustable roller spacing also reduces the risks of undesirable jamming. For example, with expandable slit cushioning material, slipping often leads to a jam. When the rollers' spacing is pre-defined, and not adjustable, there is a high likelihood of slippage; however, by providing adjustable rollers 128, 130 that can accommodate set and pre-defined spacing, the risk of slippage is greatly reduced. Moreover, rollers 128, 130 can be controlled via drive roller 126 (e.g., either the speed of the rollers as a pair, or individually), which can further reduce slippage.

In an embodiment, first roller 128 and second roller 130 are rubber rollers, such that the rollers 128, 130 may “catch” any expandable slit cushioning material that happens to slip. For example, rubber rollers improve friction contact between the pair of rollers and the cushioning material, reducing slippage.

Each of the rollers 128, 130 may advantageously include anti-jam features. For example, as illustrated by FIG. 6, first roller 128 includes anti-jam feature 132. Anti-jam feature 132 is a bar, disposed along a length of first roller 128; anti-jam feature 132 is hingedly disposed and positioned such that a small gap exists between anti-jam feature 132 and first roller 128. Anti-jam feature 132 is configured to prevent slit cushioning material from riding up first roller 128 and causing a jam. Anti-jam feature 132 “guides” slit cushioning material towards aperture 102. In an embodiment, anti-jam feature 132 is hingedly coupled to a left and right side housing of device 100. Anti-jam feature 132 is hingedly coupled in a gravity-biased orientation, such that gravity causes anti-jam feature 132 to physically prevent slit cushioning material from riding up first roller 128 and causing a jam. Similarly, second roller 130 includes anti-jam feature 134.

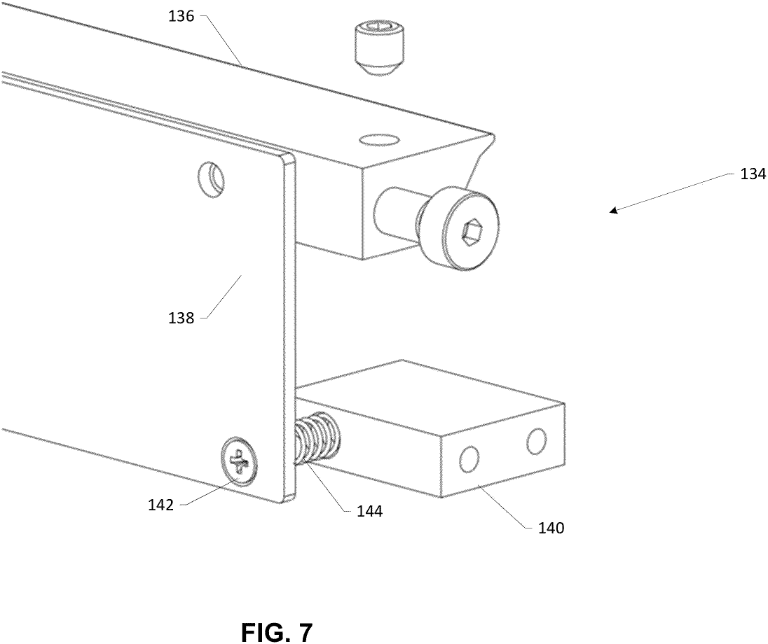

Specifically, FIG. 7 illustrates a perspective view of anti-jam feature 134, which is spring-biased. Anti-jam feature 134 includes a bar 136, disposed along a length of second roller 130 (roller not pictured). Bar 136 is coupled to a vertical bracket 138. Anti-jam feature 134 further includes a mounting block 140, which may be coupled to a left and/or right side housing of device 100. Vertical bracket 138 is adjustably coupled to the mounting block 140 via a set screw 142 and related spring 144. Thus, as illustrated in greater detail herein, each of bar 136 and vertical bracket 138 may pivot relative to mounting block 140 (and the rest of device 100) via spring 144. The degree to which bar 136 and vertical bracket 138 can pivot is adjustable by tightening/loosening set screw 142 to control the spring-constant and related deflection. Thus, anti-jam feature 134 is hingedly disposed and positioned such that a small gap exists between anti-jam feature 134 and second roller 130. Anti-jam feature 134 is configured to prevent slit cushioning material from riding up second roller 130 and causing a jam. Anti-jam feature 134 “guides” slit cushioning material towards aperture 102.

As illustrated and described herein, anti-jam features 132, 134 have differing configurations. It should be appreciated that, in an alternative embodiment, anti-jam feature 134 including spring-biasing is implemented with roller 128; similarly, in an alternative embodiment, anti-jam feature 132 including gravity-biasing is implemented with roller 130. In yet another alternative embodiment, device 100 includes two of the same type of anti-jam features (e.g., two spring-biased features, one for each of first roller 128 and second roller 130).

In an embodiment, first roller 128 and second roller 130 extend across the entire width of device 100, such that the rollers 128, 130 extend across the entire width of the expandable slit paper. In an alternate embodiment (not illustrated), the device 100 includes two separate pairs of non-continuous rollers: a first pair of rollers and a second pair of rollers. The first pair of rollers is configured to extend across a first edge of the expandable slit paper (e.g., a left edge of the paper). The second pair of rollers is configured to extend across a second edge of the expandable slit paper (e.g., a right edge of the paper). In this alternate edge-only embodiment, neither the first pair of rollers nor the second pair of rollers extend across a middle of the expandable slit paper; for example, the middle of the expandable slit paper remains untouched by rollers.

As noted previously, first roller 128 and second roller 130 are driven by a drive roller 126. FIG. 8 illustrates a perspective view of device 100 with a motor-driven gear system. Namely, drive roller 126 includes a drive roller gear 146. First roller 128 includes first roller gear 148. Second roller 130 includes second roller gear 150. The gear system may additionally include one or more idler gears, such as idler gear 152 disposed between drive roller gear 146 and second roller gear 150. Because first roller gear 148 and second roller gear 150 are meshed, first roller 128 and second roller 130 are configured to rotate in different directions (e.g., one rotates clockwise, while the other rotates counter-clockwise). This ensures both rollers rotate so as to guide slit cushioning material towards aperture 102.

Furthermore, by being motor-driven, the pair of rollers 128, 130 reduce the amount of effort needed to release the paper from the buffer zone. The pair of rollers 128, 130 will rotate in the same movement direction as the sheet material releases. By reducing the effort needed to pull the sheet material from the output chute at aperture 102, risks associated with tearing the sheet material are drastically reduced; this also reduces any risk of wasted material due to a tear and reduces likelihood of a jam.

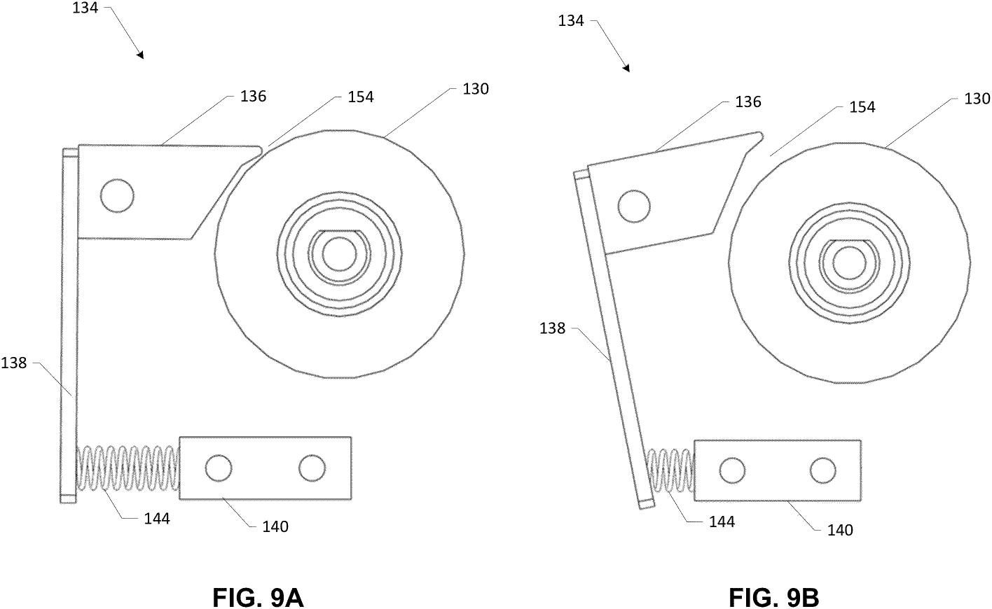

That said, FIGS. 9A to 9B illustrate side views of spring-biased anti-jam feature 134 during a jam. More specifically, as previously noted anti-jam feature 134 is hingedly disposed and positioned such that a small gap 154 exists between anti-jam feature 134 and second roller 130. Anti-jam feature 134 is configured to prevent slit cushioning material from riding up second roller 130 and causing a jam. Anti-jam feature 134 “guides” slit cushioning material towards aperture 102 (e.g., from right to left as illustrated in FIG. 9A.

To the extent device 100 inadvertently experiences a jam (e.g., slit cushioning material bunching up at gap 154), anti-jam feature 134 rotates backward (via spring 144) to increase the size of gap 154 between bar 136 and roller 130. After the jam is released (e.g., released by hand) the spring-loaded anti-jam feature 134 may be pushed back into its original position (i.e., with minimal gap 154 between the bar 136 and the roller 130).

Furthermore, for example, if a jam is caused by blocking of the aperture 102, the sheet of slit material is buffered in a chamber between the roller 130 and bar 136. This buffered material, collected between the roller 130 and bar 136, effectively “pushes” the anti-jam feature 134 and seals the gap between the bar 136 and roller 130. By sealing this gap, a “hard jam” is prevented (as there is no space between the bar 136 and roller 130 for additional slit material to collect).

In an embodiment, one or both of anti-jam features 132, 134 includes a detection switch or sensor, configured to monitor the physical positon of each of the anti-jam features 132, 134 (e.g., relative to the pair of rollers). To the extent one of the anti-jam features 132, 134 does get “pushed” out of its original position, the detection switch or sensor may deactivate the pair of rollers 128, 130 and/or may deactivate the drive roller 126. Once the pair of rollers 128, 130 is stopped (e.g., via footswitch or automated sensor-detection), the buffered sheet material can be easily released by pulling the sheet material out of the output chute at aperture 102.

In another embodiment, to the extent the anti-jam feature 134 does get “pushed” out of its original position, the detection switch or sensor may activate an automatic reverse option (e.g., for releasing a jam between the bar 136 and roller 130).

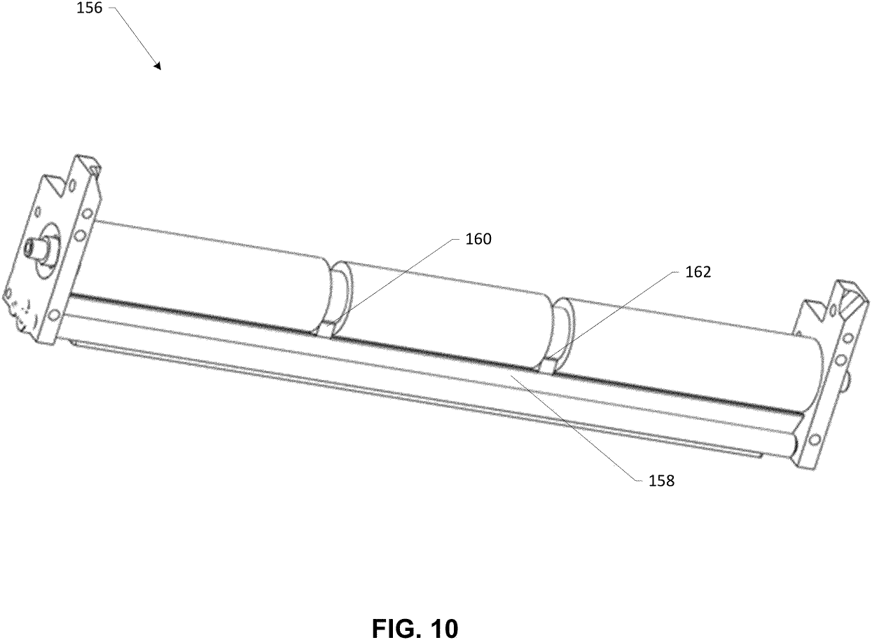

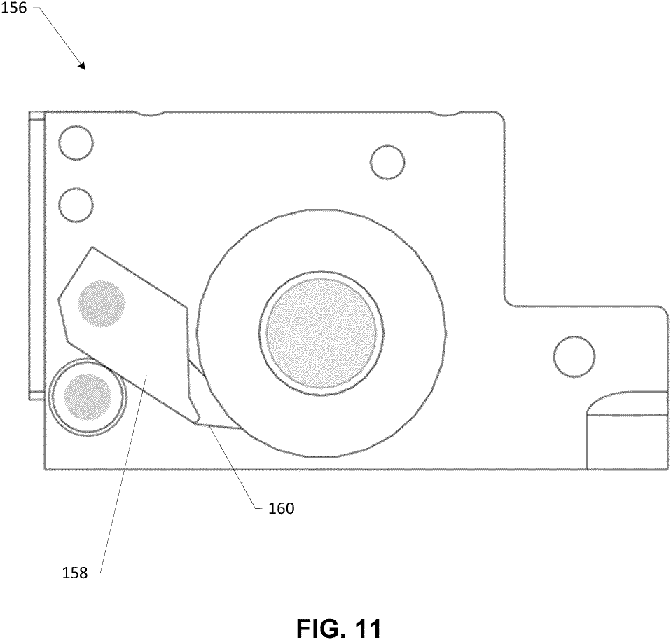

FIGS. 10 and 11 illustrate perspective and side views of an alternate roller 156. Specifically, alternate roller 156 includes an anti-jam feature 158, such as a bar disposed along a length of alternate roller 156. Anti-jam feature 158 is hingedly disposed and positioned such that a small gap exists between anti-jam feature 158 and roller 156. Anti-jam feature 158 “guides” slit cushioning material towards aperture 102. In this particular embodiment, alternate roller 156 includes a number of notches along its length (e.g., two notches, as illustrated in FIG. 10). Similarly, anti-jam feature 158 includes a plurality of guides 160, 162, such that each guide 160, 162 extends into one of the notches of alternate roller 156. Guides 160, 162 may further be configured to guide slit cushioning material towards aperture 102 while simultaneously preventing jams.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A device for dispensing a roll of sheet stock material, comprising:
a first pair of rollers,
wherein the first pair of rollers is driven by an electric motor,
wherein the first pair of rollers is configured to receive expandable slit paper between the first pair of rollers, and
wherein the first pair of rollers is configured to modify a force of friction applied to an outer surface of the expandable slit paper.

2. The device of claim 1, wherein the first pair of rollers extend across an entire width of the expandable slit paper.

3. The device of claim 1, further comprising a second pair of rollers,
wherein the first pair of rollers extend across a left edge of the expandable slit paper, and
wherein the second pair of rollers extend across a right edge of the expandable slit paper,
such that neither the first pair of rollers nor the second pair of rollers extend across a middle of the expandable slit paper.

4. The device of claim 1, including a first bracket on a left side of the device and including a right bracket on the right side of the device, such that the device is configured to be coupled to the roll of sheet stock material via the first bracket and the second bracket.

5. The device of claim 4, wherein, when the device is coupled to the roll of sheet stock material, the roll of sheet stock material is disposed vertically above the device.

6. The device of claim 4, wherein, when the device is coupled to the roll of sheet stock material, the roll of sheet stock material is disposed vertically below the device.

7. The device of claim 1, wherein the first pair of rollers includes a first roller and a second roller, wherein the first roller includes a first anti-jam device, and wherein the second roller includes a second anti-jam device.

8. The device of claim 7, wherein the first anti-jam device is a gravity-biased hinge.

9. The device of claim 7, wherein the second anti-jam device is a spring-biased hinge.

10. The device of claim 9, wherein, responsive to a jam, the second anti-jam device pivots away from the second roller.

11. The device of claim 9, wherein the second anti-jam device includes a spring, wherein the spring is adjustable via a set screw.

12. The device of claim 7, wherein the first pair of rollers includes a plurality of notches, wherein the first anti-jam device includes a plurality of fingers, and wherein each of the plurality of fingers extends into one of the plurality of notches.

13. A device for dispensing a roll of sheet stock material, comprising:
a first roller and a second roller,
wherein the first roller and the second roller are driven by an electric motor,
wherein the first roller and the second roller are configured to receive expandable slit paper between the first roller and the second roller,
wherein the first roller includes a first anti-jam device, wherein the second roller includes a second anti-jam device, and wherein the second anti-jam device is different from the first anti-jam device.

14. The device of claim 13, including a first bracket on a left side of the device and including a right bracket on the right side of the device, such that the device is configured to be coupled to the roll of sheet stock material via the first bracket and the second bracket.

15. The device of claim 14, wherein, when the device is coupled to the roll of sheet stock material, the roll of sheet stock material is disposed in a different vertical plane than a vertical plane of the device.

16. The device of claim 13, wherein the first anti-jam device is a gravity-biased hinge.

17. The device of claim 13, wherein the second anti-jam device is a spring-biased hinge.

18. The device of claim 17, wherein, responsive to a jam, the second anti-jam device pivots away from the second roller.

19. The device of claim 17, wherein the second anti-jam device includes a spring, wherein the spring is adjustable via a set screw.

20. The device of claim 13, wherein the first roller includes a plurality of notches, wherein the first anti-jam device includes a plurality of fingers, and wherein each of the plurality of fingers extends into one of the plurality of notches.
